(19) United States
(12) Patent Application Publication
(10) Pub. No.: US 2026/0141185 A1
(43) Pub. Date: May 21, 2026

(54) METHOD AND SYSTEM FOR DYNAMICALLY REFINING INPUT QUESTIONS FOR GENERATING INSIGHTS FROM A DATABASE

(71) Applicant: LTI Mindtree Ltd, Mumbai (IN)

(72) Inventors: Jeyapaul Selvaraj, Mumbai (IN); Sreetha S, Mumbai (IN); Sreelakshmi K, Mumbai (IN)

(21) Appl. No.: 19/060,906

(22) Filed: Feb. 24, 2025

(30) Foreign Application Priority Data
Nov. 19, 2024 (IN) 202421089767

(51) Int. Cl. G06F 40/40; G06F 16/334

(52) U.S. Cl. CPC G06F 40/40; G06F 16/3344

(57) ABSTRACT

A method and system for dynamically refining an input question for generating insights from a database is disclosed. A GUI receives an input from a user. A retrieval module retrieves relevant metadata entities by applying a RAG model to the input. A tokenization module determines tokens within the input based on the relevant metadata entities using an LLM. An intent module identifies an intent associated with the input using a LLM and NLP. A classification module classifies the input question into a question type using a BERT-based model. A boundary condition check is performed by condition check module to determine the completeness of the input based on the tokens, the intent, and the question type. A refinement prompt is generated upon determining incompleteness and receives a modification to the input to generate an insight when the input is determined to be complete.

### FIELD

Various embodiments of the present disclosure generally relate to refining user questions. More particularly, the disclosure relates to a method and system for dynamically refining input questions by guiding a user in creating well-structured questions to generate insights from a database.

### BACKGROUND

In the evolving landscape of Question and Answer (Q&A) systems, users increasingly seek accurate, contextual responses to their queries. However, traditional Q&A systems often assume that users can formulate well-structured questions that precisely reflect their informational needs. In practice, many users may struggle with phrasing their queries effectively, particularly when they are uncertain about specific terms or concepts related to their inquiry. This gap between user intent and system interpretation frequently leads to miscommunication and irrelevant responses, ultimately diminishing the user experience and limiting the system's effectiveness.

Also, the existing Q&A systems often struggle to accurately interpret user intent when queries are phrased in varied ways. Many traditional systems rely heavily on specific vocabulary and rigid syntax, resulting in limited flexibility in recognizing meaning across differently worded questions. These systems face a fundamental challenge in bridging the gap between “what is said” and “what is meant,” often failing to understand the true intent behind user articulation. This challenge is particularly evident when users phrase questions uniquely or employ alternative vocabulary, the system may fail to comprehend the intended query, leading to irrelevant or incomplete responses.

While some existing Q&A systems attempt to improve accuracy by drawing on user query history and referencing a knowledge base, they often fall short in guiding users to form effective queries. These systems may rely on past interactions or stored information to infer user intent, but they lack the dynamic capability to assist users in crafting questions that align with what the system can accurately address. Without active guidance in query formulation, users are left to guess at the most effective wording, which can result in misaligned queries and unsatisfactory responses.

Some modern Q&A systems and virtual assistants leverage semantic analysis, conversational context, and continuous learning to refine interactions. While these advancements enable the systems to understand context and improve over time, they remain focused primarily on enhancing response quality rather than guiding users in constructing effective queries. Without a structured, step-by-step approach to assist users in formulating questions, these systems fall short in helping users create queries that precisely capture their intent.

There is therefore a need to improve the effectiveness of question processing in database systems and address the challenges users face in formulating precise queries.

### SUMMARY

The disclosure provides a method and system for dynamically refining an input question for generating insights from a database and presenting the insights to a user. A graphical user interface (GUI) of the system receives an input from the user. A retrieval module retrieves one or more relevant metadata entities by applying a retrieval-augmented-generation (RAG) model to the input question. A tokenization module determines one or more tokens within the input question based on the relevant metadata entities, by leveraging a large language model (LLM). An intent module identifies an intent associated with the input question using a LLM and Natural Language Processing techniques. A classification module classifies the input question into a plurality of question types using a BERT-based model.

A boundary condition check is then performed by the condition check module to determine the completeness of the input question based on the one or more tokens, the intent, and the question type. A prompt module generates a refinement prompt upon determining incompleteness and receives a modification to the input question to generate insights when the question is determined to be complete, and outputs the insights to the user.

One or more advantages of the prior art are overcome, and additional advantages are provided through the disclosure. In addition to illustrative aspects, embodiments, and features described above, further aspects, embodiments, and features will become apparent by reference to drawings and following detailed description.

### BRIEF DESCRIPTION OF THE FIGURES

FIG. 1 is a diagram that illustrates an exemplary environment within which various embodiments of the present disclosure may function.

FIG. 2 is a diagram that illustrates a system for dynamically refining input questions for generating insights from a database, in accordance with an embodiment of the disclosure.

FIG. 3 is an exemplary diagram that illustrates the framework of the system refining input questions for generating insights from the database, in accordance with an embodiment of the disclosure.

FIG. 4 is a diagram that illustrates a flow chart for a method for dynamically refining input questions for generating insights from a database, in accordance with an embodiment of the disclosure.

### DETAILED DESCRIPTION

Pursuant to various embodiments, the method and system dynamically refines an input question for generating insights from the database. A graphical user interface (GUI) receives an input from a user. A retrieval module retrieves one or more relevant metadata entities by applying a retrieval-augmented-generation (RAG) model to the input question. A tokenization module determines one or more tokens within the input question based on the relevant metadata entities, by leveraging a large language model (LLM). An intent module identifies an intent associated with the input question using a LLM and Natural Language Processing techniques. A classification module classifies the input question into a plurality of question types using a BERT-based model. A boundary condition check is then performed by the condition check module to determine the completeness of the input question based on the one or more tokens, the intent, and the question type. A prompt module generates a refinement prompt upon determining incompleteness and receives a modification to the input question to generate an insight when the question is determined to be complete, and outputs the insight to the user.

In one or more embodiments, the BERT-based model is trained using domain-independent data, where actual entities have been replaced with generalized tags, such as MEASURE, DIMENSION, VALUE, and DATE, to allow for flexible application across multiple domains. The BERT model functions as a sequence classification tool and is trained on a dataset of over numerous data points to ensure accuracy and adaptability in identifying various question types.

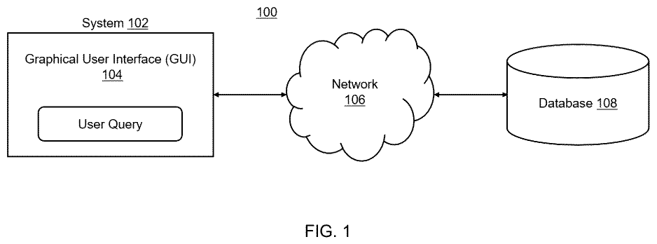

FIG. 1 is a diagram that illustrates an exemplary environment 100 within which various embodiments of the present disclosure may function. Referring to FIG. 1, the environment 100 comprises a system 102 with a graphical user interface (GUI) 104, a network 106, and a database 108.

As shown in FIG. 1, the system 102 is enabled to dynamically refine input questions provided by the user to generate insights from the database 108. The system 102 dynamically refines the input questions by assisting the user in formulating qualified questions through one or more prompts, messages and signifiers. The system 102 is also enabled to perceive the underlying objective of the input question from the user, ensuring all information is present for the question to be complete to enhance the quality of responses.

The GUI 104 of the system 102 refers to an interactive platform where a user can enter initial questions. The GUI is also designed to receive inputs of various types, allowing for flexible and adaptable user interactions.

In one or more embodiments, the GUI 104 refers to a visual interface that enables the user to interact with electronic devices through graphical elements, such as icons, buttons, and windows. The intuitive design simplifies the user experience by allowing individuals to navigate and execute tasks more easily.

In some non-limiting embodiments, the GUI 104 is designed to receive a diverse range of input types and forms, accommodating various user preferences and operational needs such as keyboard and mouse interactions, as well as modalities like touch, voice recognition, and natural language processing.

The network 106 includes communication networks operable to facilitate communication, either wirelessly or wired. The network 106 connects a plurality of computer systems. The network 106 may comprise, for example, an intranet, local area network, wide area network, the internet, public switched telephone network (PSTN), network of networks, or other network.

In one or more embodiments, the network 106 facilitates connection between the system 102 and the database 108 via one or more communication channels.

The database 108 serves as a central repository for storing various types of structured and unstructured data relevant to the system's 102 operations. Configured with appropriate logic, interfaces, and code, the database 108 is designed to support the complex data requirements of the environment 100, allowing it to efficiently manage and retrieve large volumes of information.

In one or more embodiments, the database 108 may store metadata entities, vector embeddings, domain-specific ontologies, and other information generated by the system's 102 models and modules, enabling real-time retrieval and processing of data as needed.

In some non-limiting embodiments, the database 108 can be implemented as any data storage and management system, including but not limited to cloud-based platforms, data lakes, distributed storage systems, business databases, or file storage systems capable of handling both structured and unstructured data. The structured data may include essential organizational information such as customer records, transaction histories, product details, and operational metrics. The unstructured data may include files, audio recordings, video content, PDFs, images, and other forms of binary data typically stored as binary large objects (BLOBs) or in object storage systems. The database 108 may further include metadata associated with both structured and unstructured records, enabling the system 102 to leverage detailed contextual information during query processing. By structuring and organizing data, including unstructured content, in a manner that reflects real-world business entities and relationships, the database 108 enables enhanced analysis and supports insights that are relevant to specific organizational objectives, irrespective of the underlying data storage architecture.

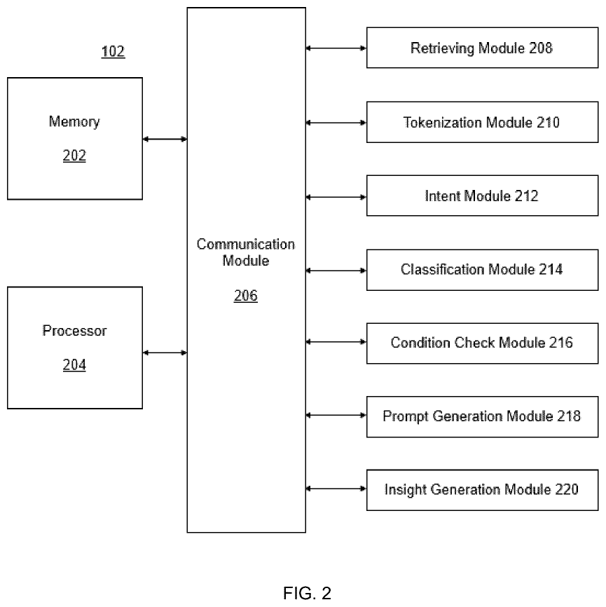

FIG. 2 is a diagram that illustrates a system 102 for dynamically refining input questions for generating insights from the database 108, in accordance with an embodiment of the present disclosure. Referring to FIG. 2, the system 102 comprises a memory 202, a processor 204, a communication module 206, a retrieving module 208, a tokenization module 210, an intent module 212, a classification module 214, a condition check module 216, a prompt generation module 218, and an insight generation module 220.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 102 in accordance with various aspects of the present disclosure. The processor 204 may be further configured to communicate with various modules of the system 102 via the communication module 206.

The retrieving module 208 may comprise suitable logic, interfaces, and/or code that may be configured to implement a Retrieval-Augmented Generation (RAG) model for context-aware question processing. The RAG model performs a two-stage process: first retrieving relevant contextual information from the database 108, and then using this retrieved information to enhance understanding of the input question. The retrieval process ensures that relevant metadata entities are identified from the database 108, while the generation phase integrates this contextual information with the question analysis.

In one or more embodiments, the retrieving module 208 processes the input question through an encoding pipeline to generate its vector representation. The retrieving module 208 employs advanced encoding techniques, such as neural network-based encoders, to transform the input question into a high-dimensional vector space. This vector representation captures semantic relationships and contextual nuances of the question, enabling more accurate similarity matching with stored metadata entities. The encoding process may utilize pre-trained transformer-based models, such as MPNet-based embeddings or similar architectures, that support bidirectional encoding capabilities for capturing contextual relationships within the input question. These models may be fine-tuned on domain-specific data to enhance encoding accuracy and improve the quality of vector representations. The bidirectional processing enables the model to consider both forward and backward contexts simultaneously, leading to more comprehensive semantic understanding of the input question.

In one or more embodiments, after encoding, the retrieving module 208 executes a similarity search within the database 108 to identify relevant metadata entities. The retrieving module 208 calculates similarity scores between the question's vector representation and the pre-computed vectors of metadata entities using metrics such as cosine similarity or dot product. The similarity calculation process includes: (a) normalizing the vector representations for consistent comparison, (b) computing similarity scores using the selected metric, and (c) applying a dynamic threshold to filter relevant matches. The retrieving module 208 prioritizes metadata entities with similarity scores exceeding the threshold, ensuring retrieval of the most contextually relevant information.

In one or more embodiments, once the relevant metadata entities are retrieved, they are aggregated with the original input question to form an augmented context. The augmented context combines the user's question with the relevant information from the metadata, providing a richer, more comprehensive understanding of the query. The aggregation process can involve concatenating the input question with the metadata entities or employing methods like attention mechanisms or knowledge fusion techniques to dynamically integrate the retrieved information. The augmented context is then used as input for the next step in the process, typically for generating a more informed and context-aware response to the user query.

The tokenization module 210 may comprise a suitable logic, interface, and/or code that is configured to determine one or more tokens within the input question based on the one or more relevant metadata entities. The process involves breaking down the input question into smaller units (tokens), which could be individual words, phrases, or symbols that carry significant meaning within the context of the input question. The tokenization module 210 identifies these tokens by examining the relationship between the input question and the relevant metadata entities, ensuring that the tokens selected are closely aligned with the key concepts or information needed to accurately address the user's question.

In one or more embodiments, the tokenization module 210 processes questions across various domains while maintaining context-awareness. For instance, when processing a question like “What are the best practices for cloud data security?”, the tokenization module 210 identifies domain-specific tokens such as “cloud,” “data,” and “security,” while also recognizing compound concepts like “best practices.” Ability of the tokenization module 210 to identify both individual tokens and their semantic relationships enables precise question analysis.

In one or more embodiments, the tokenization module 210 utilizes a fine-tuned LLM that processes both the input question and the relevant metadata entities retrieved by the retrieving module 208. The LLM undergoes a domain-agnostic training process across diverse sectors such as manufacturing, finance, healthcare, consumer goods, media, and education. This multi-domain training approach enhances the model's ability to perform token identification tasks while minimizing domain-specific biases. Rather than embedding domain-specific knowledge, the training focuses on developing robust token identification and relationship mapping capabilities that are universally applicable across different business contexts. This approach enables the LLM to maintain consistent performance regardless of the domain while accurately processing specialized terminology and contextual relationships. The fine-tuning process ensures that the model can accurately identify and process tokens that are particularly relevant to the system's 102 operational domain.

In one or more embodiments, the tokenization module 210 implements a multi-step token extraction process. First, the tokenization module 210 feeds both the input question and relevant metadata entities into the fine-tuned LLM. The LLM then analyzes these inputs to identify domain-specific entities, attributes, and their relationships. The tokenization module 210 maintains a structured representation of identified tokens, preserving their contextual relationships and significance within the question's framework.

In one or more embodiments, the tokenization module 210 adapts its token identification process based on the specific domain context. For example, in a medical context, the module identifies specialized tokens such as “disease,” “symptom,” or “treatment” as critical entities, while in a financial context, it recognizes terms like “investment,” “return,” or “risk” as key tokens. The tokenization module 210 also extracts and categorizes associated attributes, such as severity levels for medical conditions or duration periods for financial metrics, ensuring comprehensive token identification that supports accurate question understanding.

The intent module 212 may comprise suitable logic, interface, and/or code that is configured to identify an intent associated with the input question using a LLM. The intent module 212 leverages advanced natural language processing techniques to analyze the question's underlying purpose and context, ensuring accurate intent classification for subsequent processing steps.

In one or more embodiments, the intent module 212 employs a separate, specialized LLM that is trained to recognize different types of user intents based on large-scale linguistic patterns and domain-specific language. The LLM can analyze the question and interpret its meaning beyond the surface-level wording. The LLM's deep understanding of language nuances allows it to differentiate between similar queries with distinct intents.

In one or more embodiments, the intent module 212 implements multiple natural language processing (NLP) techniques to enhance intent identification. These techniques include, but are not limited to, advanced tokenization that segments questions into meaningful units, part-of-speech tagging that identifies grammatical roles of words, dependency parsing that maps relationships between words, and named entity recognition (NER) that identifies and classifies key elements within the question. The combination of these techniques enables comprehensive intent analysis.

In one or more embodiments, the intent module 212 determines the relevant metadata entities and applies predefined intent identification instructions. The intent module 212 first analyzes the input question to identify important concepts, keywords, or data points, which are often found in the metadata entities related to the question. The metadata entities provide the foundational understanding of the user's query. Along with these entities, the intent module 212 also utilizes predefined intent identification instructions, which serve as guidelines or rules that help the system 102 classify the type of request being made.

The one or more NLP techniques are then employed to decompose the input question into its constituent elements. This decomposition reveals the structural relationships between different parts of the question and identifies key semantic patterns. The intent module 212 analyzes these patterns in conjunction with the metadata context to determine the precise nature of the user's request.

In one or more embodiments, the intent module 212 utilizes a domain-optimized version of the LLM, specifically fine-tuned for understanding specialized queries. This fine-tuning process involves training the model with domain-specific datasets, enabling it to accurately interpret intent within particular contexts (such as healthcare, finance, or legal domains). The intent module 212 processes the input question alongside the metadata entities and intent identification instructions to generate accurate intent predictions.

As part of intent identification, the intent module 212 focuses on determining the type of analysis requested by the user, which includes categorizing the question based on their analytical requirements. The intent module 212 identifies whether a question requires statistical analysis, trend evaluation, decision support, or predictive modeling. For example, when processing a question like “What is the projected growth rate for this product over the next five years?”, the intent module 212 classifies it as a predictive analysis request, ensuring appropriate handling in subsequent processing stages.

One or more embodiments, the intent module 212 implements temporal pattern recognition to identify time-related aspects of user queries. The intent module 212 analyzes questions for temporal markers that indicate specific timeframes, historical trends, or future projections. This temporal analysis is crucial for questions involving time-series data, trend analysis, or forecasting requirements.

In an exemplary embodiment, the temporal patterns may refer to various indicators within the question that define or suggest a time frame, such as explicit dates, periods, intervals, or references to past or future events. For instance, when analyzing a question such as “What were the sales figures for Q2 2023?”, the module identifies “Q2 2023” as a specific temporal marker, enabling accurate time-bound data retrieval and analysis. The module maintains a structured representation of these temporal patterns to support precise query processing.

The classification module 214 may comprise suitable logic, interface, and/or code that is configured to classify the input question into a question type of a plurality of question types. Each question type corresponds to specific categories of inquiries and is associated with one or more required elements or entities that are essential for understanding and processing the query effectively.

In an exemplary embodiment, the classification module 214 analyzes the input question and determines its type within the framework of the semantic model. A question type can refer to various analytical categories based on the nature of the inquiry. For example, a question could be classified as informational (e.g., “What is the market share trend for Product X?”, “What is the correlation between sales and marketing spend?”), comparative (e.g., “How does the growth rate of Region A compare to Region B?”), decision-based (e.g., “Which product line should we expand based on profitability trends?”), or diagnostic (e.g., “What factors are driving the decrease in customer retention?”). For informational queries, the classification module 214 recognizes various analytical subtypes including ratio analysis, share calculations, delta-on-share computations, correlation analysis, and growth rate determinations, enabling comprehensive insight generation from the semantic model.

Each identified question type is further associated with specific required elements and entities that are essential for generating an accurate response. For example, an informational question might require the system 102 to retrieve factual data, such as geographic or historical information, while a decision-based question might involve analyzing variables such as financial metrics or risk factors. By associating the input question with a particular question type, the classification module 214 ensures that the necessary data elements such as attributes, values, or entities are recognized and retrieved.

In one or more embodiments, the classification module 214 converts the question into a domain-independent format. This step is crucial for standardizing the question so that it can be processed regardless of the specific domain or industry context. The input question is broken down into its constituent tokens (such as words or phrases), and each token is tagged based on its characteristics. These characteristics might include the part of speech (e.g., noun, verb, adjective), the syntactic role (e.g., subject, object), or its semantic meaning (e.g., location, time, entity).

After converting the input question into a domain-independent format, the classification module 214 classifies the question into one of the predefined question types. This is achieved by applying a fine-tuned BERT-based neural network model.

The fine-tuned BERT-based neural network model leverages both the syntactic structure and semantic meaning derived from the domain-independent format of the input question to identify the question type. It does so by considering the relationships between the tagged tokens and the overall intent of the query. Since BERT is bidirectional, it examines the context surrounding each token, allowing it to determine how tokens interact with one another, thereby improving classification accuracy.

In one or more embodiments, the system 102 then performs a boundary condition check using the condition check module 216 to determine completeness of the input question based on the one or more tokens, the intent, and the question type.

In one or more embodiments, the condition check module 216 examines the tokens within the input question. The tokens represent the individual components or words that make up the question, and their arrangement provides crucial insights into the structure and meaning of the query. The condition check module 216 evaluates whether any essential tokens are missing or if any critical information is underrepresented. For example, if the user asks, “What is the revenue for Q1?” but omits the specific company or product, the condition check module 216 may recognize this as an incomplete question and request clarification, such as, “Which company's revenue for Q1 are you asking about?”

The intent identified in the previous stages is then assessed for completeness. The condition check module 216 checks whether the intent aligns with the question type and whether all necessary components required to fulfill the user's request are present. For instance, if the user's question indicates a request for financial data, but there is no indication of the time period (e.g., “revenue for the last quarter” vs. “revenue for this year”), the condition check module 216 may flag this as incomplete and request additional information.

In one or more embodiments, the system 102 evaluates the question type to ensure that the question is formulated in a manner that corresponds to one of the predefined categories (e.g., informational, comparative, or decision-based). Each question type may require a different set of tokens, intent clarity, or contextual information. If the system 102 detects inconsistencies such as a question that is categorized as informational but lacks critical data points the boundary condition check will flag it as incomplete.

The prompt generation module 218 may comprise suitable logic, interfaces, and/or code that is configured to generate a refinement prompt for the user, upon determining the input question is incomplete. The prompt generation module 218 is designed to assist the user in refining the input question whenever it is deemed incomplete based on the boundary condition check.

In one or more embodiments, the prompt generation module 218 selects a prompt template that aligns with the missing elements identified during the boundary condition check. The prompt generation module 218 utilizes a set of prompt templates designed to address various types of missing information, such as missing entities, time periods, or comparison parameters. Based on the specific elements that are absent in the user's question, the prompt generation module 218 chooses the most suitable template. For example, if a temporal context is missing, a template prompting for time-related information (e.g., “Could you specify the time frame you're interested in?”) would be selected.

In one or more embodiments, once the appropriate template is selected, the prompt generation module 218 generates a natural language prompt that includes one or more specific actions for the user to refine their input question. The prompt may contain one or more of a request for specific information related to the missing elements, a suggestion to remove unnecessary elements identified during analysis of the input question, and a request for clarification of unrecognized tokens identified during the boundary condition check

In one or more embodiments, the prompt directly asks for any critical information that is missing. For instance, if the question is about “revenue” but lacks specifics such as the product or timeframe, the prompt might say, “Please specify the product and time period for which you'd like revenue information.”

In one or more embodiments, if the input question contains extraneous or irrelevant details, the prompt generation module 218 suggests removing them. For example, if the question includes additional details that don't align with the question type, the prompt could guide the user to focus on the essential elements, improving clarity and relevance. A suggestion might read, “Consider removing unrelated details to focus on the primary question.”

In one or more embodiments, if there are any unrecognized tokens the prompt generation module 218 doesn't understand or cannot categorize, the prompt will include a request for clarification. This helps avoid misinterpretations and ensures that each component of the question is understood. For instance, the system 102 might prompt, “Could you clarify what you mean by ‘X’?”

In one or more embodiments, in response to the prompts generated by the prompt generation module 218, the system 102 receives a modification to the input question from the user via the GUI 104. The modified input question may address any missing elements, clarify ambiguities, or focus the query more precisely based on the feedback provided by the refinement prompt.

In one or more embodiments, via the GUI 104 the user can easily input the responses, making the modification process straightforward and user-friendly. For example, if the initial question lacked a specific time frame, the user might update the question to include a time-related parameter. Similarly, if the system 102 prompted for clarification on a term, it did not recognize, the user can redefine or elaborate on that term within the modified question.

Upon receiving the modified input, the system 102 initiates a re-evaluation process to verify the completeness and coherence of the updated question. This involves reapplying the boundary condition check and analyzing the tokens, intent, and question type once again to ensure all necessary components are now present. Through the iterative interaction, the system 102 can progressively guide the user toward crafting a more effective and complete question, ultimately enhancing the accuracy and relevance of the insights generated.

The insight generation module 220 may comprise suitable logic, interface, and/or code that is configured to generate insights based on the input question when determined to be complete.

In one or more embodiments, once the input question is determined to be complete, having passed the boundary condition check with all necessary elements, intent, and context, the insight generation module 220 processes the question by analyzing it in conjunction with an underlying semantic model and data structures. The insight generation module 220 leverages advanced algorithms to interpret the question accurately, retrieve relevant information, and apply any required business logic or analytical techniques.

In some non-limiting embodiments, the insight generation module 220 can generate insights in various formats, such as statistical summaries, visualizations, or concise text responses, tailored to suit the question type and user needs. By combining data retrieval and intelligent interpretation, the insight generation module 220 ensures that the user receives a comprehensive, actionable insight, improving decision-making and enhancing the overall querying experience.

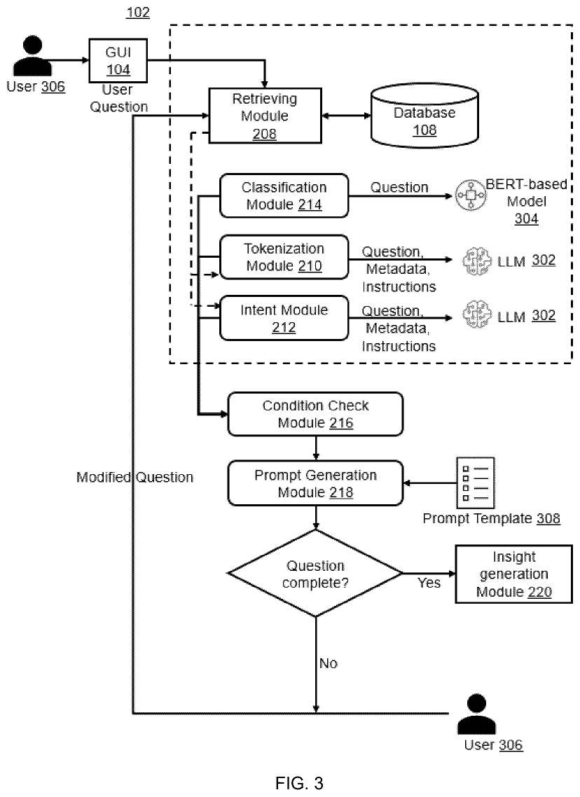

FIG. 3 is an exemplary diagram that illustrates the framework of the system 102 along with the GUI 104 in refining input questions for generating an insight from the database 108, in accordance with an embodiment of the disclosure.

In this exemplary scenario, a user 306 initiates interaction with the system 102 through the GUI 104 by submitting a business query (an input question): “Which has the highest revenue?”. The system 102 processes the business query through its analysis pipeline to ensure completeness and accuracy.

Upon receiving the input question, the retrieving module 208 first applies the RAG model to process the question. The RAG model converts the question into a vector representation and compares it against the semantic knowledge base. Through this comparison, the retrieving module 208 identifies that while “revenue” isn't directly present in the semantic model, it maps to “Sales” as the closest matching business metric, demonstrating the system's 102 ability to handle terminology variations.

The tokenization module 210 then processes the question using the LLM 302 to identify specific tokens within the context established by the retrieved metadata. During this analysis, “highest” is identified as a superlative comparison token, while “revenue” is mapped to its semantic model equivalent “Sales”. The tokenization module 210 analyzes these tokens'relationships to understand their analytical significance within the question framework.

Subsequently, the intent module 212 performs a detailed analysis of the question to determine the user's 306 intent. Through this analysis, the intent module 212 identifies that the question carries a comparative analysis intent, specifically focused on identifying a maximum value within a dimension. This intent identification helps establish the analytical framework required for processing the query.

The classification module 214, employing its BERT-based model 304, processes the input question next and categorizes it as a “which” type comparison question. Based on this classification, the module identifies that such questions require specific elements for complete analysis: primarily a dimension specification (such as product, region, or time period) along which the comparison should be performed.

Through this multi-stage analysis, the condition check module 216 evaluates the question's completeness and determines it to be incomplete. The check reveals a critical missing element: there is no dimension specification indicating the scope of comparison (such as products, regions, or time periods) required for performing the maximum value analysis of Sales.

In some non-limiting embodiments, the boundary condition check may leverage a token-based model that identifies essential entities, attributes, and relationships specific to the input question. The model dynamically adjusts based on the identified question type and corresponding data requirements, ensuring that the system 102 can handle a wide range of question formulations without human intervention. The check uses a combination of rule-based logic and machine learning models trained on domain-specific queries, allowing it to account for a diverse set of question structures across multiple industries (e.g., finance, healthcare, retail).

After determining the missing dimension requirement, the prompt generation module 218 initiates its refinement process. The prompt generation module 218 accesses its repository of prompt template 308, where each template is specifically designed to address different types of missing information or ambiguities in queries. The template selection process considers multiple factors including the type of missing information, the domain context, and the overall question structure.

In some non-limiting embodiments, the system 102 utilizes a prompt template selection mechanism to dynamically generate prompts that guide the user 306 in refining their input question. When the system 102 identifies an incomplete query, it initiates a prompt generation process by selecting an appropriate template based on the specific elements missing from the question. Each prompt template is pre-defined to address particular gaps, such as requesting details about specific entities, clarifying ambiguous terms, or identifying necessary contextual information related to the user's 306 intent.

In some non-limiting embodiments, the system 102 utilizes a fine-tuned version of a pre-trained LLM that has been specifically adapted to the domain of the user's 306 query. The model has undergone extensive training on industry-specific datasets comprising millions of query-response pairs. The training process incorporates domain ontologies and business taxonomies, optimizing the model for context-aware prompt generation. The model continuously learns from successful query refinement patterns, improving its ability to generate effective prompts.

In this specific case, the prompt generation module 218 formulates a clear, natural language prompt that reads: “Please specify the dimension (such as product, region, or time period) across which you would like to find the highest Sales.” This prompt directly addresses the missing dimension requirement while maintaining the context of the original query.

The prompt could also suggest removing unnecessary details if any irrelevant information is found. For example, if the user 306 included information that is extraneous or irrelevant to the query, the system 102 might advise focusing on the core question. Additionally, the system 102 may also generate additional clarification prompts if it encounters unclear terms or requires more specific information. For instance, if multiple dimension options are available in the semantic model, it might ask the user 306 to specify their preferred dimension for the analysis.

Upon receiving these refinement prompts through the GUI 104 the user 306 modifies the original input question to include the missing information. The modified input question might now read: “Which product has the highest revenue?” This modified question includes the necessary dimension specification for performing the comparative analysis.

Once the user 306 submits the updated question, the system 102 performs another round of boundary condition checks. This re-check verifies that the modified question is now complete and includes all the required tokens, intent, and elements. The system 102 analyzes the updated question and confirms that it now meets the requirements for generating an insight.

Upon validation of the input question's completeness, the insight generation module 220 begins processing the query to generate relevant insights. The insight generation module 220 accesses the financial database, utilizing the now-complete context to analyze Sales figures across all products. The semantic model enables accurate interpretation of the comparison requirement, ensuring that the maximum value analysis is performed correctly across the specified product dimension.

In one or more embodiments, the semantic model of the system 102 is developed based on actual data and business inputs or knowledge. The semantic model incorporates comprehensive metadata details, including measure and dimension names, potential synonyms, and any associated business terminology relevant to these entities. Additionally, the semantic model captures properties such as type classifications (e.g., location, additive, non-additive). The metadata information is stored in a vector database, enabling efficient retrieval and matching.

The insight generation module 220 then formulates a clear, contextual response such as: “Product A has the highest Sales at $10 million.” This response includes the dimension context from the refined question, ensuring clarity and accuracy in the insight provided.

This insight is presented to the user 306 via the GUI 104, where they can view the result of their query.

If the user 306 wishes to refine the query further or asks additional questions, the system 102 can continue to guide the user 306 in a similar manner, using prompts and re-evaluations to ensure each new query is complete and appropriately structured. This iterative process not only enhances the user's 306 experience but also ensures that each query results in accurate, actionable insights.

This example demonstrates how the system 102 systematically identifies incomplete questions, guides users through the refinement process, and ultimately generates accurate insights once all necessary information is provided. The iterative refinement process ensures that the final response precisely matches the user's 306 information needs while maintaining the accuracy and relevance of the generated insights.

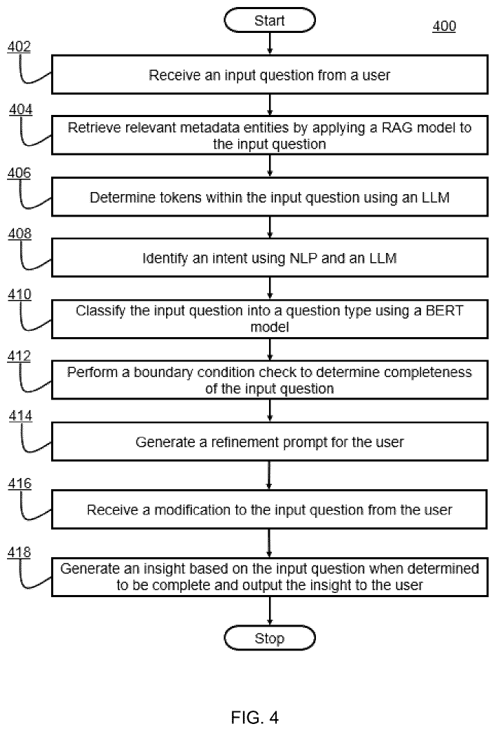

FIG. 4 is a diagram that illustrates a flow chart 400 for a method for dynamically refining input questions for generating an insight from the database 108, in accordance with an embodiment of the disclosure.

At 402, the system 102 receives an input question from the user via the GUI 104. The GUI 104 of the system 102 refers to an interactive platform where a user can enter initial questions. The GUI is also designed to receive inputs of various types, allowing for flexible and adaptable user interactions.

In one or more embodiments, the GUI 104 refers to a visual interface that enables the user to interact with electronic devices through graphical elements, such as icons, buttons, and windows. The intuitive design simplifies the user experience by allowing individuals to navigate and execute tasks more easily.

At 404, one or more relevant metadata entities are retrieved by the retrieving module 208 by applying a RAG model to the input question. The RAG model performs the retrieval process by retrieving pertinent information or metadata from the vector database 108 or knowledge base and then generating contextually relevant responses based on the retrieved data.

In one or more embodiments, the retrieving module 208 transforms the input question provided by the user into a vector representation using a suitable encoding technique, such as word embeddings, sentence embeddings, or contextual embeddings generated by models like BERT or GPT. The vector representation captures the semantic meaning of the question in a high-dimensional space, where similar meanings are closer to each other.

In one or more embodiments, after encoding the input question, the retrieval module 208 searches for relevant metadata entities within the database 108 by comparing the encoded vector of the input question with pre-stored vectors representing the metadata entities in the system 102. A similarity measure, such as cosine similarity, Euclidean distance, or other relevant distance metrics, may be applied to determine how closely the vector of the input question matches the vectors of the metadata entities. The retrieval module 208 retrieves the metadata entities whose vectors exhibit the highest similarity to the input question vector, ensuring that the returned data is contextually relevant.

In one or more embodiments, once the relevant metadata entities are retrieved, they are aggregated with the original input question to form an augmented context. The augmented context combines the user's question with the relevant information from the metadata, providing a richer, more comprehensive understanding of the query. The aggregation process can involve concatenating the input question with the metadata entities or employing methods like attention mechanisms or knowledge fusion techniques to dynamically integrate the retrieved information. The augmented context is then used as input for the next step in the process, typically for generating a more informed and context-aware response to the user query.

At 406, one or more tokens within the input question are determined by the tokenization module 210 using a LLM based on the one or more relevant metadata entities.

At 408, an intent within the input question is identified by the intent module 212 using natural language processing techniques and a large language model (LLM). The process involves breaking down the input question into smaller units (tokens), which could be individual words, phrases, or symbols that carry significant meaning within the context of the input question. The tokenization module 210 identifies these tokens by examining the relationship between the input question and the relevant metadata entities, ensuring that the tokens selected are closely aligned with the key concepts or information needed to accurately address the user's question.

In one or more embodiments, the intent module 212 employs a separate, specialized LLM that is trained to recognize different types of user intents based on large-scale linguistic patterns and domain-specific language. The LLM can analyze the question and interpret its meaning beyond the surface-level wording. The LLM's deep understanding of language nuances allows it to differentiate between similar queries with distinct intents.

In one or more embodiments, alongside the LLM, the intent module 212 may use one or more NLP techniques, such as tokenization, part-of-speech tagging, dependency parsing, and named entity recognition (NER), to further analyze the question. The techniques help identify key elements such as verbs (action words), nouns (objects or subjects), and contextually important phrases that can provide insight into the user's intent.

In one or more embodiments, the intent module 212 determines the relevant metadata entities and applies predefined intent identification instructions. The intent module 212 first analyzes the input question to identify important concepts, keywords, or data points, which are often found in the metadata entities related to the question. The metadata entities provide the foundational understanding of the user's query. Along with these entities, the intent module 212 also utilizes predefined intent identification instructions, which serve as guidelines or rules that help the system 102 classify the type of request being made.

At 410, the input question is classified into a question type of a plurality of question types by the classification module 214 using the BERT-based model. In one or more embodiments, the classification module 214 converts the question into a domain-independent format. This step is crucial for standardizing the question so that it can be processed regardless of the specific domain or industry context. The input question is broken down into its constituent tokens (such as words or phrases), and each token is tagged based on its characteristics. These characteristics might include the part of speech (e.g., noun, verb, adjective), the syntactic role (e.g., subject, object), or its semantic meaning (e.g., location, time, entity).

After converting the input question into a domain-independent format, the classification module 214 classifies the question into one of the predefined question types. This is achieved by applying a fine-tuned BERT-based neural network model.

At 412, the boundary condition check is performed by the condition check module 216 to determine completeness of the input question based on the one or more tokens, the intent, and the question type.

In one or more embodiments, the condition check module 216 examines the tokens within the input question. Tokens represent the individual components or words that make up the question, and their arrangement provides crucial insights into the structure and meaning of the query. The condition check module 216 evaluates whether any essential tokens are missing or if any critical information is underrepresented. For example, if the user asks, “What is the revenue for Q1?” but omits the specific company or product, the condition check module 216 may recognize this as an incomplete question and request clarification, such as, “Which company's revenue for Q1 are you asking about?”

At 414, upon determining the input question is incomplete, the prompt generation module 218 generates the refinement prompt for the user. The prompt generation module 218 is designed to assist the user in refining the input question whenever it is deemed incomplete based on the boundary condition check.

In one or more embodiments, the prompt generation module 218 selects a prompt template that aligns with the missing elements identified during the boundary condition check. The prompt generation module 218 utilizes a set of prompt templates designed to address various types of missing information, such as missing entities, time periods, or comparison parameters. Based on the specific elements that are absent in the user's question, the prompt generation module 218 chooses the most suitable template. For example, if a temporal context is missing, a template prompting for time-related information (e.g., “Could you specify the time frame you're interested in?”) would be selected.

In one or more embodiments, once the appropriate template is selected, the prompt generation module 218 generates a natural language prompt that includes one or more specific actions for the user to refine their input question. The prompt may contain one or more of a request for specific information related to the missing elements, a suggestion to remove unnecessary elements identified during analysis of the input question, and a request for clarification of unrecognized tokens identified during the boundary condition check

At 416, a modification to the input question from the user is received by the system 102 from the user via the GUI 104. The modified input question may address any missing elements, clarify ambiguities, or focus the query more precisely based on the feedback provided by the refinement prompt.

In one or more embodiments, via the GUI 104 the user can easily input the responses, making the modification process straightforward and user-friendly. For example, if the initial question lacked a specific time frame, the user might update the question to include a time-related parameter. Similarly, if the system 102 prompted for clarification on a term, it did not recognize, the user can redefine or elaborate on that term within the modified question.

At 418, the insight generation module 220 generates an insight based on the input question when determined to be complete, and outputs the insight to the user on the GUI 104. The insight generation module 220 leverages advanced algorithms to interpret the question accurately, retrieve relevant information, and apply any required business logic or analytical techniques.

In some non-limiting embodiments, the insight generation module 220 can generate insights in various formats, such as statistical summaries, visualizations, or concise text responses, tailored to suit the question type and user needs. By combining data retrieval and intelligent interpretation, the insight generation module 220 ensures that the user receives a comprehensive, actionable insight, improving decision-making and enhancing the overall querying experience.

The method and system is advantageous over existing solutions in that it provides a highly interactive query-assistance system that enables users to formulate questions in a way that optimally leads them to relevant information. By guiding users through the process of asking well-structured questions, the system enhances their ability to access specific insights without needing prior expertise in technical querying methods. Additionally, the method and system offers contextual suggestions that align users'inquiries with the system's data structure and semantic capabilities, ensuring that questions are both understandable and actionable.

The method and system is also advantageous in that it clarifies which aspects of a user's question are understood by the system, providing transparency about what the system can and cannot address. By highlighting the elements of the question that align with its analytical capabilities, the system helps users better understand how their input corresponds with the data and insights available. Furthermore, the system notifies users of any missing elements needed to complete the question, as well as any extraneous information that may not be relevant to generating the desired insights. This allows users to modify and refine their questions more effectively, focusing only on necessary components. Through this guidance, users are empowered to adapt their inquiries to better fit the system's strengths, ensuring that the system's responses are more accurate, efficient, and insightful.

Additionally, the system implements Parameter-Efficient Fine-Tuning (PEFT) techniques on large language models, allowing it to adapt to diverse question formulations while maintaining computational efficiency. This fine-tuned approach enables the system to process natural language queries without requiring users to adhere to rigid syntactic rules or specific technical phrasing. By accommodating diverse language patterns and variations in question structure, users can phrase their queries using different word choices, sentence structures, or terminology while still receiving accurate and relevant responses. This flexibility in language processing ensures that users can interact with the system comfortably, expressing queries in their own words while maintaining high response accuracy. Moreover, while conventional natural language processing systems often rely on fixed templates or predefined patterns, the PEFT-enhanced language model adds specialized layers that adapt to the system's specific capabilities without modifying the base model's parameters. This architectural approach preserves the model's fundamental language understanding capabilities while enabling efficient adaptation to domain-specific requirements, resulting in a more versatile system that can handle varied question formats while maintaining optimal computational resource utilization.

Significantly, the method and system employs a tightly integrated transformer model and semantic model to effectively interpret the intent behind user questions and streamline the query experience. By leveraging the transformer's contextual analysis and the semantic model's understanding of underlying relationships and business logic, the system can precisely discern the user's intent from varied language inputs.

Moreover, once the intent is identified, the system intuitively guides the user to provide any necessary information that may be missing while also suggesting the removal of unnecessary details that could complicate or misdirect the query. Through this guided experience, the system helps users refine their questions in real time, ultimately leading them toward well-defined, efficient queries that are more likely to yield accurate and relevant insights. This combined use of the transformer and semantic models not only enhances the accuracy of intent recognition but also elevates the user experience by making the process of asking questions more intuitive, focused, and aligned with the system's capabilities.

Furthermore, the method and system utilizes a range of advanced AI models to enhance question interpretation and response accuracy. By employing a robust, transfer-based model for recognizing various question types, the system can categorize user queries efficiently, improving its ability to provide relevant responses. Additionally, a fine-tuned language model is integrated to interpret each token within user questions, identify temporal patterns, and accurately discern the underlying intent. These AI models are seamlessly incorporated to create a powerful, contextually aware system that delivers more precise, insightful, and relevant answers, ultimately enriching the user's experience.

Moreover, the method and system streamlines the querying process, enhancing the overall user experience by making it more intuitive and efficient. By guiding users in asking well-structured questions, the system not only simplifies the process but also significantly improves user satisfaction. Through precise and contextually rich responses, the disclosure enables users to make more informed and effective decisions, as they can access accurate insights that align closely with their intent.

What is claimed is:

1. A computer-implemented method for dynamically refining input questions for generating an insight from a database, comprising:
receiving, by one or more processors, an input question from a user;
retrieving, by the one or more processors, one or more relevant metadata entities by applying a retrieval-augmented-generation (RAG) model to the input question;
determining, by the one or more processors, using a large language model (LLM) one or more tokens within the input question based on the one or more relevant metadata entities;
identifying, by the one or more processors, using natural language processing techniques and a large language model (LLM), an intent associated with the input question;
classifying, by the one or more processors, using a BERT-based model, the input question into a question type of a plurality of question types, wherein each question type is associated with one or more required elements and entities;
performing, by the one or more processors, a boundary condition check to determine completeness of the input question based on the one or more tokens, the intent, and the question type;
upon determining the input question is incomplete, generating, by the one or more processors, a refinement prompt for the user;
receiving, by the one or more processors, a modification to the input question from the user;
generating, by the one or more processors, an insight based on the input question when determined to be complete; and
outputting, by the one or more processors, the insight to the user.

2. The method of claim 1, wherein retrieving the one or more relevant metadata entities comprises:
encoding the input question into a vector representation;
retrieving the one or more relevant metadata entities by comparing the vector representation with stored metadata entity vectors using a similarity measure; and
aggregating the one or more relevant metadata entities with the input question to generate an augmented context.

3. The method of claim 1, wherein determining the one or more tokens comprises:
providing the input question and the one or more relevant metadata entities to an instructional fine-tuned large language model, wherein the large language model is fine-tuned using domain-specific instructional data; and
extracting, using the fine-tuned large language model, domain-specific entities and attributes from the input question.

4. The method of claim 3, wherein the one or more tokens comprise at least one of business entities, attributes associated with the business entities, conditions, aggregation functions, time periods and comparison operators.

5. The method of claim 1, wherein identifying the intent comprises determining, based on the input question, the one or more relevant metadata entities, and one or more predefined intent identification instructions, using the natural language processing techniques and a fine-tuned version of the large language model, an intent of the input question, wherein the intent indicates a type of analysis requested by the user, and one or more temporal patterns associated with the intent.

6. The method of claim 5, wherein determining the intent and the one or more temporal patterns comprises: analyzing contextual meanings of the tokens using the natural language processing techniques; and interpreting complex temporal dependencies using the fine-tuned large language model.

7. The method of claim 5, wherein the intent comprises at least one of a trend analysis, a comparative analysis, a root cause analysis, an anomaly detection, a correlation analysis, a forecasting, and an impact analysis.

8. The method of claim 1, wherein classifying the input question comprises:
converting the input question into a domain-independent format by tagging the one or more tokens based on their characteristics; and
determining, using a fine-tuned BERT-based neural network model, a question type for the domain-independent format of the input question.

9. The method of claim 8, wherein the fine-tuned BERT based neural network model comprises a portion of pre-trained non-trainable layers and a portion of fine-tuned layers trained using domain-specific question type data.

10. The method of claim 8, wherein a question type comprises at least one of a what-if question, a why question, a how question, a when question, a where question, and a who question.

11. The method of claim 1, wherein performing the boundary condition check comprises:
determining one or more required elements for the question type;
comparing the one or more tokens and the intent against the one or more required elements; and
identifying missing elements needed to generate a complete insight.

12. The method of claim 11, wherein the one or more required elements comprise at least one of: business entities required for the question type, temporal parameters required for the intent, comparison parameters for comparative analysis, and context specifications for the intent.

13. The method of claim 11, wherein generating the refinement prompt comprises:
selecting a prompt template based on results of the boundary condition check; and
generating a natural language prompt that includes one or more of a request for specific information related to the missing elements, a suggestion to remove unnecessary elements identified during analysis of the input question, and a request for clarification of unrecognized tokens identified during the boundary condition check.

14. The method of claim 1, wherein the database comprises enterprise data sources accessible for business intelligence operations.

15. The method of claim 14, wherein the one or more relevant metadata entities comprise at least one of business metric definitions, key performance indicators, business hierarchies, and data relationships across enterprise data sources.

16. The method of claim 14, wherein the insight comprises business insights derived from at least one of historical trends, performance comparisons, anomaly detections, and predictive analytics.

17. A system for dynamically refining input questions for generating an insight from a database, comprising:
one or more processors; and
a memory storing instructions that, when executed by the one or more processors, cause the system to perform operations comprising:
receiving an input question from a user; retrieving one or more relevant metadata entities by applying a retrieval-augmented-generation (RAG) model to the input question;
determining, using a large language model (LLM), one or more tokens within the input question based on the one or more relevant metadata entities;
identifying, using natural language processing techniques and a large language model (LLM), an intent associated with the input question;
classifying, using a BERT-based model, the input question into a question type of a plurality of question types, wherein each question type is associated with one or more required elements and entities;
performing a boundary condition check to determine completeness of the input question based on the one or more tokens, the intent, and the question type;
upon determining the input question is incomplete, generating a refinement prompt for the user;
receiving a modification to the input question from the user;
generating an insight based on the input question when determined to be complete; and
outputting the insight to the user.

18. The system of claim 17, wherein retrieving the one or more relevant metadata entities comprises:
encoding the input question into a vector representation;
retrieving the one or more relevant metadata entities by comparing the vector representation with stored metadata entity vectors using a similarity measure; and
aggregating the one or more relevant metadata entities with the input question to generate an augmented context.

19. The system of claim 17, wherein determining the one or more tokens comprises:
providing the input question and the one or more relevant metadata entities to an instructional fine-tuned large language model, wherein the large language model is fine-tuned using domain-specific instructional data; and
extracting, using the fine-tuned large language model, domain-specific entities and attributes from the input question.

20. The system of claim 17, wherein identifying the intent comprises:
determining, based on the input question, the one or more relevant metadata entities, and one or more predefined intent identification instructions, using the natural language processing techniques and a fine-tuned version of the large language model, an intent of the input question, wherein the intent indicates a type of analysis requested by the user and one or more temporal patterns associated with the intent.

21. The system of claim 17, wherein classifying the input question comprises:
converting the input question into a domain-independent format by tagging the one or more tokens based on their characteristics; and
determining, using a fine-tuned BERT-based neural network model, a question type for the domain-independent format of the input question.

22. The system of claim 17, wherein performing the boundary condition check comprises:
determining one or more required elements for the question type;
comparing the one or more tokens and the intent against the one or more required elements; and
identifying missing elements needed to generate a complete insight.

23. The system of claim 22, wherein generating the refinement prompt comprises:
selecting a prompt template based on the identified missing elements; and
generating a natural language prompt that includes one or more of a request for specific information related to the missing elements, a suggestion to remove unnecessary elements identified during analysis of the input question, and a request for clarification of unrecognized tokens identified during the boundary condition check.
